(19) United States
(12) Patent Application Publication
(10) Pub. No.: US 2008/0126779 A1
(43) Pub. Date: May 29, 2008

(54) Methods and apparatus to perform secure boot

(76) Inventor: Ned Smith, Beaverton, OR (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/523,388

(22) Filed: Sep. 19, 2006

(51) Int. Cl. G06F 9/00

(52) U.S. Cl. 713/2

(57) ABSTRACT

Methods and apparatus are disclosed to perform a secure boot of a computer system. An example method disclosed herein receives an initialization routine having at least one sub-routine, measures the initialization routine to compute a hash value, and compares the computed hash value with a core root of trust hash value to verify the initialization routine. The example method disclosed herein also establishes trust to the initialization routine when the computed hash value matches the core root of trust hash value and hands-off platform hardware to an operating system in response to successful verification of the initialization routine. Other embodiments are described and claimed.

### FIELD OF THE DISCLOSURE

This disclosure relates generally to computer systems and, more particularly, to methods and apparatus to perform secure boot of computer systems.

### BACKGROUND

A boot process is a multi-step process that typically includes invocation of numerous low level drivers for hardware, firmware, and other services that allow a computer platform to operate from an initially powered-down state. Computing devices, personal computers, workstations, and servers (hereinafter “computer,” “computers,” or “platform”) typically include a basic input/output system (BIOS) as an interface between computer hardware (e.g., a processor, chipsets, memory, etc.) and a software operating system (OS). The BIOS includes firmware and/or software code to initialize and enable low-level hardware services of the computer, such services include basic keyboard, video, disk drive, input/output (I/O) port(s), and chipset drivers (e.g., memory controllers) associated with a computer motherboard.

Throughout the multi-step boot process, the platform may be susceptible to erroneous executables that are part of the BIOS initialization process. Erroneous executables may be the result of hardware errors when saving to and/or reading from memory. For example, a data saving operation abruptly interrupted by a power failure may result in incomplete and/or erroneously stored data. Additionally, the executables used during initialization may be compromised by viruses and/or other breaches of malicious intent. Although many OSs include various types of anti-virus software to minimize and/or prevent viruses, worms, spyware, etc., such anti-virus benefits typically do not become fully effective during the platform pre-OS initialization process. That is, anti-virus effectiveness typically depends upon a fully operational OS. Accordingly, if malicious code compromises the platform prior to the OS initialization (e.g., during the platform initialization), then subsequent anti-virus application(s) that operate during OS runtime may be of little use.

### BRIEF DESCRIPTION OF THE DRAWINGS

FIG. 1 is a block diagram of an example system capable of performing a secure boot.

FIG. 2 is a flowchart illustrating an example process to perform a secure boot for the example system of FIG. 1.

FIG. 3 is a flowchart illustrating an example process to configure non-volatile memory as part of the example process of FIG. 2 for the example system of FIG. 1.

FIG. 4 is a flowchart illustrating an example process to perform measurement, verification, and starting of a software image as part of the example process of FIG. 2.

FIG. 5 is a flowchart illustrating an example process to retrieve policy information as part of the example process of FIG. 4.

### DETAILED DESCRIPTION

Establishing a core root of trust (CRT) originating from hardware, rather than software, promotes a more secure platform environment that is less susceptible to malicious circumvention. That is, while software/firmware may be altered to include undesired information (e.g., bugs, viruses, etc.), the same is not true for hardware. In one example, a trusted platform module (TPM) is added to the platform and includes an endorsement key (e.g., a private key usable in a private/public pair key scenario) and a secure micro-controller to facilitate cryptographic functionalities. The TPM may be implemented as hardware and include a variety of chips (chipset). The chipset may include, but is not limited to, read-only memory (ROM), random access memory (RAM), flash memory, one or more microprocessors, and/or microcontrollers. The endorsement key(s) is generated in the TPM, thereby preventing outside exposure while the TPM further prevents hardware and software agents from having any access to the cryptographic functionalities and/or secure non-volatile (NV) random access memory (RAM). Input/Output (1/O) to/from the TPM may only be accomplished via a suitable communications interface that authenticates the user(s) and/or device(s) requesting services and/or access.

The TPM typically includes tamper-protected packaging to more easily identify whether a read-only memory (ROM) chip(s), and/or any other part of the TPM, has been physically accessed and/or replaced. In particular, any private keys used by the TPM for cryptographic functionality may be stored on ROM to minimize/eliminate software-based attacks on the platform intended to, for example, replace the private key(s) with an alternate key value. The TPM may also include other modules including, but not limited to, various amounts of NV storage, platform configuration registers (PCRs), a random number generator (RNG), cryptographic hash engines, such as a secure hash algorithm (SHA) for computing signatures, a Rivest/Shamir/Adleman (RSA) algorithm for signing, encryption, and/or decryption, and/or signature engines, such as an RSA engine.

The TPM may establish the CRT in a variety of ways, including generation of the endorsement key during the platform manufacturing process prior to end-user delivery. Upon initial platform power-up, which is presumably under the control of an end-user, the end-user may be authenticated to allow access to the suite of TPM services (e.g., the end-user is associated with the endorsement key generated during the manufacturing process) while preventing any outside exposure of the endorsement key generated during the manufacturing process. Alternatively, the platform may ship with the TPM in a pre-endorsement key state. The initial user establishes authentication credentials for subsequent use and the TPM generates the endorsement key(s) during this configuration process. In either example, the endorsement key(s) never leaves the confines of the TPM hardware, thereby minimizing opportunities for the circumvention of the CRT.

The CRT may extend/propagate trust to other parts of the platform based on, for example, end-user established policy credentials being satisfied. Generally speaking, a chain of trust may be extended from the CRT as each policy binary (e.g., one or more executable software programs in a chain of BIOS instructions) is verified as safe. Accordingly, if each stage of platform initialization is incrementally verified, then BIOS hand-off to the OS may occur in a more secure manner with reduced concern that pre-OS malicious code has infiltrated the platform during the chain of execution.

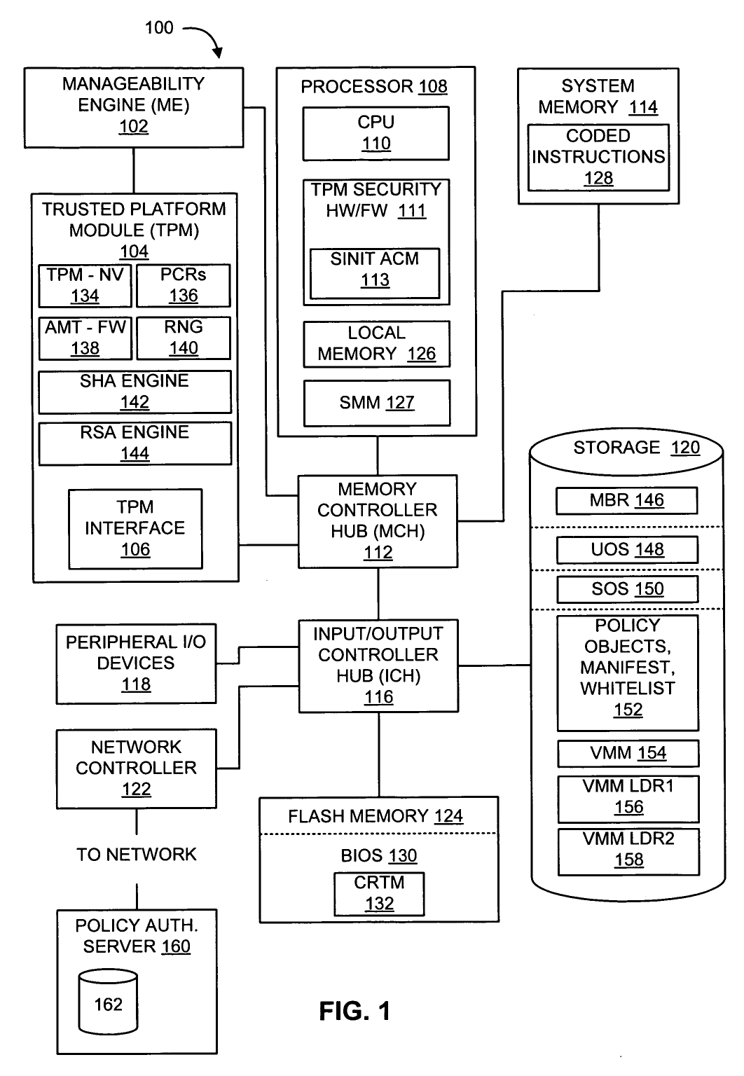

FIG. 1 is a block diagram of an example system 100 for performing a secure boot, including a manageability engine (ME) 102 capable of invoking services (e.g., cryptographic processes) of a TPM 104. As discussed in further detail below, the TPM 104 includes a non-volatile memory (TPM-NV) 134, a plurality of process control registers (PCRs) 136, Active Management Technology firmware (AMT-FW) 138, a random number generator 140, an SHA engine 142, and an RSA engine 144. Communication to/from the TPM 104 occurs via a TPM interface 106.

The example system 100 also includes a processor 108, which may include, but is not limited to, a central processing unit (CPU) 110, TPM security hardware 111, such as the LaGrande Technology (LT) firmware developed by Intel®, a system initialization (SINIT) authorization code module (ACM) 113, local memory 126, and system management mode (SMM) firmware 127. In the illustrated example, the platform 100 includes system memory 114 on which coded instructions 128 are stored, a memory controller hub (MCH) 112, and an I/O controller hub (ICH) 116. The ICH 116 is operatively connected to peripheral I/O devices 118, storage devices 120, a network controller 122, and a flash memory 124, which may include a BIOS 130 and a core root of trust for measurement (CRTM) 132. The example storage device 120 includes, but is not limited to, a master boot record (MBR) 146, a user operating system (UOS) 148, a service operating system (SOS) 150, a module for policy objects, manifests, and/or whitelists 152, a virtual machine monitor (VMM) 154, a VMM first loader (VMM LDR1) 156, and a VMM second loader (VMM LDR2) 158.

The example system 100 also includes a policy authoring server 160 having storage 162. As discussed in further detail below, the policy authoring server 160 may provision policies to the TPM 104 if, for example, the storage 120 has a finite capacity and/or outdated policy. In the illustrated example, the policy authoring server 160 communicates with the network controller 122 and provides policies maintained in the storage 162 to the TPM 104 via the TPM interface 106.

In general, the ME 102 associated with one or more of the blocks of system 100 employs the TPM interface 106 to allow system level software and firmware (e.g., pre-operating system software, runtime management mode firmware, etc.) to invoke various TPM 104 cryptographic processes (e.g., generating security keys, data encryption and/or decryption, data certification and/or verification, identity authentication and/or verification, software authentication and/or verification, etc.). The ME 102 may implement roots of trust, such as the CRTM 132 and/or the SINIT ACM 113 of the TPM security hardware/firmware 111. Similarly, the TPM 104 may also implement such roots of trust. The ME 102 is capable of executing exclusively of and/or simultaneously with the processor 108 of the example system 100. In other words, if system level software, firmware, or hardware requires performance of a cryptographic process, the ME 102 can perform the cryptographic process while the CPU 110 continues to execute further instructions. Generally speaking, as each software program, firmware program, binary, and/or other executable attempts to execute on the platform 100 (e.g., various facets of BIOS routines), the ME 102 first passes the requesting software program to the TPM 104. As a result, the TPM 104 measures the software program to calculate a hash value, and verifies the calculated hash value with the CRT. Software programs having verified hash values are allowed to proceed to execution, while software programs having hash values that fail based on a lack of parity with the CRT are deemed untrustworthy.

In the illustrated example, the TPM security hardware/firmware 111 is part of the processor 108, but persons of ordinary skill in the art will appreciate that the TPM security hardware/firmware 111 may be integral with the CPU 110 and/or implemented on the platform as a separate chipset module. The example TPM security hardware/firmware 111 also employs the SINIT ACM 113 to provide processor instructions requested by the ME 102. The platform 100 is booted in a verified manner by employing integrity measurement roots from the TPM security hardware/firmware 111, the SINIT ACM 113, and/or the CRTM 132 combined with various measurement, verification, and reporting operations of the TPM 104.

The processor 108 can be implemented using one or more Intel® microprocessors from the Pentium® family, the Itanium® family, the XScale® family, or the Centrino™ family. Of course, other processors from other families and/or other manufacturers are also appropriate. While the example system 100 is described as having a single CPU 110, the system 100 may alternatively have multiple CPUs. The example system/platform 100 can be, for example, a server, a personal computer, a personal digital assistant (PDA), or any other type of computing device. The local memory 126 of the processor 108 may execute coded instructions, coded instructions 128 present in RAM 114, and/or coded instructions in another memory device. The processor 108 may also execute firmware instructions stored in the flash memory 124 or any other instructions transmitted to the processor 102. Additionally, the processor 108 may employ SMM code 127 to manage CPU 110 error events, if any. For example, a laptop low battery condition is an error event that SMM code 127 is typically designed to handle with an interrupt that saves the CPU 110 state in a specific portion of memory until the error is abated (e.g., a controlled power-down).

In the example of FIG. 1, the processor 108 is coupled with the MCH 112. The MCH 112 provides an interface to the ME 102 and RAM 114. Persons of ordinary skill in the art will appreciate that the system 100 may also include read-only memory (ROM). The MCH 112 is also coupled with the ICH 116.

The ME 102 provides security and/or cryptographic functionality. In one example, the ME 102 may be implemented as the TPM 104. ME 102 provides a secure identifier such as a cryptographic key, in a secure manner to the MCH 112, or any other component of the system 100.

The system memory 114 may be any volatile and/or non-volatile memory that is connected to the MCH 112 via, for example, a bus. For example, volatile memory may be implemented by Synchronous Dynamic Random Access Memory (SDRAM), Dynamic Random Access Memory (DRAM), RAMBUS Dynamic Random Access Memory (RDRAM), and/or any other type of random access memory device. Non-volatile memory may be implemented by flash memory and/or any other desired type of memory device.

The ICH 116 provides an interface to the peripheral 1/O devices 118, the storage 120, the network controller 122, and the flash memory 124. The ICH 116 may be connected to the network controller 122 using a peripheral component interconnect (PCI) express (PCIe) interface or any other available interface.

The peripheral I/O devices 118 may include any number of input devices and/or any number of output devices. The input device(s) permit a user to enter data and commands into the system 100. The input device(s) can be implemented by, for example, a keyboard, a mouse, a touchscreen, a track-pad, a trackball, isopoint and/or a voice recognition system. The output devices can be implemented, for example, by display devices (e.g., a liquid crystal display, a cathode ray tube display (CRT), a printer and/or speakers). The peripheral I/O devices 118, thus, typically include a graphics driver card. The peripheral I/O devices 118 also include a communication device such as a modem or network interface card to facilitate exchange of data with external computers via a network (e.g., an Ethernet connection, a digital subscriber line (DSL), a telephone line, coaxial cable, a cellular telephone system, etc.).

The storage 120 is one or more storage device(s) storing software and data. Examples of storage 120 include floppy disk drives, hard drive disks, compact disk drives, and digital versatile disk (DVD) drives.

The network controller 122 provides an interface to an external network and/or the policy authoring server 160, as described above. The network may be any type of wired or wireless network connecting two or more computers. The network controller 122 also includes a management agent (MA) housing the ability to perform cryptographic processes. In addition, the network controller 122 with MA includes an interface that allows system software (e.g., BIOS software, pre-operating system software, runtime management mode software, etc.) to instruct the network controller 122 with MA to perform cryptographic processes on behalf of the system software. The network controller 122 with MA may operate independently of the operation of the processor 108. For example, the network controller 122 with MA may include a microprocessor, a microcontroller or other type of processor circuitry, memory, and interface logic. One example implementation of the network controller 122 with MA is the Tekoa Management controller within the Pro 1000 Gigabit Ethernet controller from Intel® Corporation.

The flash memory 124 is a system memory storing instructions and/or data (e.g., instructions for initializing the system 100). For example, the flash memory 124 may store BIOS software 130. The BIOS software 130 may be an implementation of the Extensible Firmware Interface (EFI) as defined by the EFI Specifications, version 2.0, published January 2006, available from the Unified EFI Forum.

As discussed in further detail below, the BIOS 130 includes the CRTM 132 that serves as a genesis for trust. Additional integrity measurement roots may include the TPM security hardware/firmware 111, such as ACMs of the LT firmware developed by Intel®. Upon a CRTM 132 foundation, subsequent BIOS processes may be measured and verified prior to platform execution to minimize any breaches of platform integrity. In other words, because BIOS is typically composed of a plurality of initialization routines/executables, some of which are dependent upon successful initialization and/or execution of prior routines, the CRTM 132 may operate on and/or verify each individual BIOS routine in a sequential manner. Without limitation, the CRTM 132 and integrity roots of trust in the TPM security hardware/firmware 111 may be combined and/or otherwise available to the TPM 104 prior to implementing a verified platform 100 boot. For example, the CRTM 132 may be aware of the ACM 113, which registers designated memory, enables memory protection, and/or determines that platform hardware is properly configured. Persons of ordinary skill in the art will appreciate that TPM security hardware/firmware 111, such as the LT technology developed by Intel®, employs various ACM 113 functions to protect hardware. For example, LT processors employ a memory scrubbing process in the event of an unanticipated processor reset, thereby preventing the possibility of untrusted software accessing privileged memory and/or memory contents.

For example, the BIOS routine may include sub-routines “A,” “B,” and “C.” Sub-routine “A” may be the CRTM 132 that has been measured and verified by the TPM 104 in view of the ACM 113, as requested by the ME 102. Although the example sub-routines “B,” and “C” require successful execution of sub-routine “A,” the TPM 104 will not permit execution of sub-routines “B” and “C” because trust only extends as far as sub-routine “A” by virtue of its prior measurement and verification. Accordingly, sub-routine “A” is deemed an extension of the CRTM 132. However, upon measurement and successful verification of sub-routine “B,” trust will be extended/propagated to include sub-routine “B.” The iterative extension of trust propagates in the aforementioned manner through all or part of the platform 100 initialization process to eliminate and/or minimize a malicious breach of the initialization code.

The flash memory 124 may be coupled to the network controller 122 using a serial peripheral interface (SP?) or any other available interface. The instructions stored in the flash memory 124 are capable of transmitting requests to perform cryptographic processes to the network controller 122 and receiving the result of such requests. In the example system 100, the flash memory 124 also stores data and/or instructions for use by the network controller 122.

As discussed above, the TPM 104 may include various modules. In the illustrated example, the TPM 104 includes non-volatile memory 134, which may include RAM and/or ROM. The ROM may be populated with the endorsement key(s) at the time of manufacture, and such ROM may be potted, or otherwise secured in a tamper resistant manner. The TPM 104 may also include a number of PCRs 136 to store various hash values during initialization verification processes, as discussed in further detail below. Various features of AMT 138 may also reside in the TPM 104, which may include firmware and/or software to, in part, allow remote management of the system 100 regardless of processor 108 power status, remotely troubleshoot the system 100, track hardware and/or software upgrades, and/or alert IT staff of system 100 status in an effort to abate potential problems before significant effects occur. Cryptographic capabilities for the TPM 104 may be realized via the RNG 140, the SHA engine 142, and/or the RSA engine 144. As discussed in further detail below, the SHA engine 142 may be employed to compute hash values of data, the random number generator 140 assists in key generation, and the RSA engine 144 facilitates encryption, decryption, digital signing, and/or key wrapping operations.

While the example TPM 104 is shown in FIG. 1 external to the ME 102 as an independent module (e.g., a separate chipset), the TPM 104 may be incorporated with the ME 102. Additionally, while the example TPM 104 includes various modules therein, such as non-volatile memory 134, PCRs 136, AMT-FW 138, RNG 140, the SHA engine 142, and the RSA engine 144, such modules may be external to the TPM 104 and invoked when needed. For example, the TPM-NV 134 may be located in the flash memory 124.

In the illustrated example, the storage 120 includes memory allocation for policy objects, manifests, and whitelists (152), which may store a plurality of hash values associated with executable code intended for execution by the processor 108. In the event that the platform is, optionally, employed as a virtual machine, the example storage 120 includes the VMM 154, the VMM first loader (LDR1) 156, and the VMM second loader (LDR2) 158. However, persons of ordinary skill in the art will appreciate that the methods and apparatus to perform secure boot described herein may be accomplished on any platform having, for example, a single CPU and a single OS, a single CPU with multiple virtual modes, and/or a platform having multiple CPUs.

Generally speaking, the system 100 allows a platform to boot in a secure manner by starting from a secure/trusted origination point, such as the CRTM 132. The ME 102 invokes the TPM 104 to measure a hash value of the CRTM 132 and verify that CRTM hash value with a hash value stored in secure memory (external to the TPM 104 or within the TPM 104) before allowing any code to be executed by the processor 108. Alternatively, verification may occur subsequent to code execution, such that an execution halt may be invoked if erroneous and/or malicious code is detected. Such verification may occur incrementally so that malicious circumvention opportunities during the multi-stage BIOS initialization process are minimized. Additionally, the system 100 allows any firmware code, chipset code, code stored on processor(s), and/or code stored on CPUs to be verified by the TPM 104 before execution. Such code may include, but is not limited to, SMM 127 code and SINIT ACM 113 code, and/or other software/firmware implemented by the TPM security hardware/firmware 111, such as the LT technology developed by Intel®.

In one example, an end-user receives a platform, such as the system 100 shown in FIG. 1, directly from the manufacturer. Association between the receiving end-user and the TPM 102 occurs at initial power-up of the platform, in which the end-user's authentication credentials are stored in TPM-NV 134 of the TPM 102. Additionally, the CRTM 132 is measured for the first time to create a unique hash value based on the endorsement key created during the manufacturing process or during the initial power-up by the end-user. The CRTM 132 hash value is stored in TPM-PCRs 136 for later comparison so that the CRTM 132 may serve as the genesis of trusted operation. Hash values stored in the TPM-NV 134 may be referred to as policies of trusted applications/data. Writing to the TPM-NV 134 for policy additions and/or updates may only occur by way of an authenticated user.

Subsequent power-up of the system 100 begins with a chipset reset of the ME 102. The ME 102 initializes the TPM 104 via the TPM INT 106 and measures the CRTM 132 to generate a hash value. In the illustrated example, all communication and/or command requests to the TPM 104 are handled by the TPM INT 106, which may include low level drivers (e.g., TPM device drivers) that are invoked via higher level library calls. The TPM INT 106 prevents unfettered external access to the resources and/or hardware of the TPM 104, thereby enhancing platform integrity. Additionally, the TPM 104 and the TPM-NT 106 are OS independent. For example, the TPM INT 106 may expose a C-language interface to allow the end-user to invoke TPM operations, such as protected functions and/or cryptographic functions.

The resulting hash value of the measured CRTM 132 is stored in a PCR 136 to allow the TPM 104 to compare the measured hash with the secure hash previously stored as a policy in the TPM-NV 134. Verification occurs if the two hashes match, such that the requesting CRTM 132 is deemed valid and allowed to be started (i.e., executed by the processor 108). Upon successful verification the ME 102 invokes a CPU reset, thereby resulting in the CPU executing from the reset vector. Persons of ordinary skill in the art will appreciate that the system 100 may be initialized with an inherent trust assumption that the ME 102 integrity has not been breached, or the system 100 may initialize from a trusted genesis established by a hash verification between the measured initialization code hash value and the policy hash value stored in TPM-NV 134. Regardless of how the system 100 establishes a core root of trust, the secure boot process extends/propagates that trust in an incremental manner for each software executable to the point of OS hand-off. The boot process may include, but is not limited to, incremental measurements, verifications, loading, and starting of the CRTM 132, the BIOS 130, the SMM 127, the MBR 146, the VMM 154, the VMM LDR1 156, the VMM LDR2 158, the SINIT ACM 113, the SOS 150, the UOS 148, and/or the SMM 127.

Having described the architecture of one example system that may be used to perform a secure boot, various processes are described. Although the following discloses example processes, it should be noted that these processes may be implemented in any suitable manner. For example, the processes may be implemented using, among other components, software, or firmware stored on a tangible media (e.g., memory, optical media, magnetic media, flash, RAM, ROM, etc.) and executed on hardware (e.g., a processor, a controller, etc.). However, this is merely one example and it is contemplated that any form of logic may be used to implement the systems or subsystems disclosed herein. Logic may include, for example, implementations that are made exclusively in dedicated hardware (e.g., circuits, transistors, logic gates, hard-coded processors, programmable array logic (PAL), application-specific integrated circuits (ASICs), etc.) exclusively in software, exclusively in firmware, or some combination of hardware, firmware, and/or software. Additionally, some portions of the process may be carried out manually. Furthermore, while each of the processes described herein is shown in a particular order, persons having ordinary skill in the art will readily recognize that such an ordering is merely one example and numerous other orders exist. Accordingly, while the following describes example processes, persons of ordinary skill in the art will readily appreciate that the examples are not the only way to implement such processes.

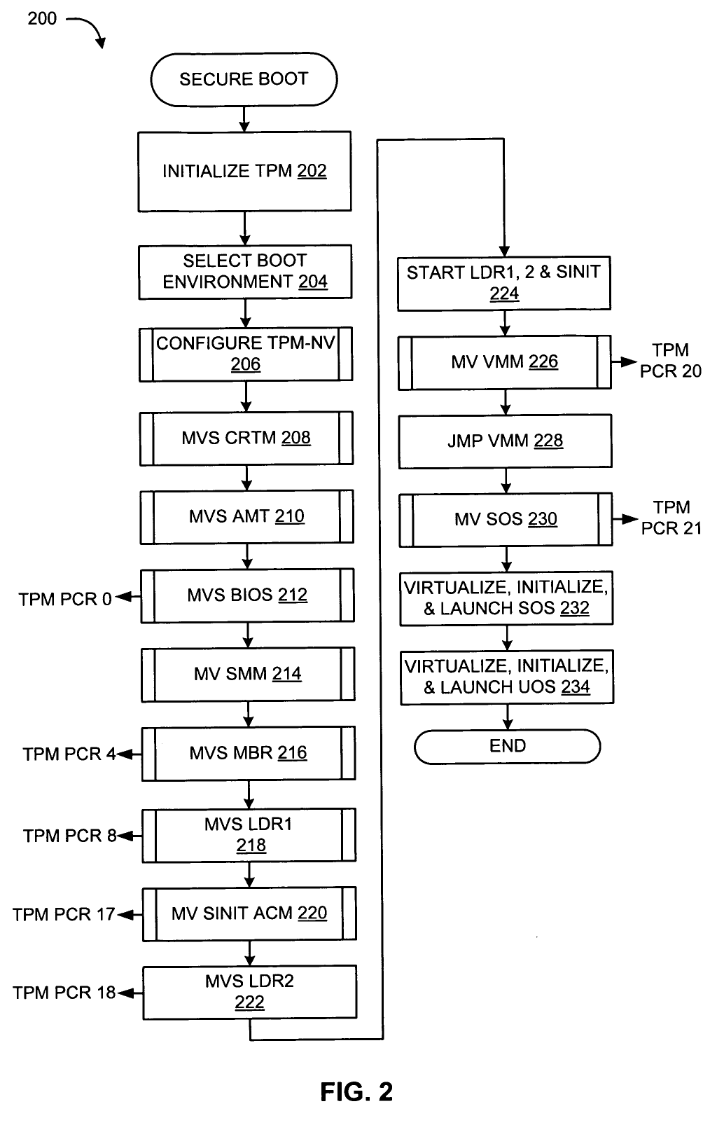

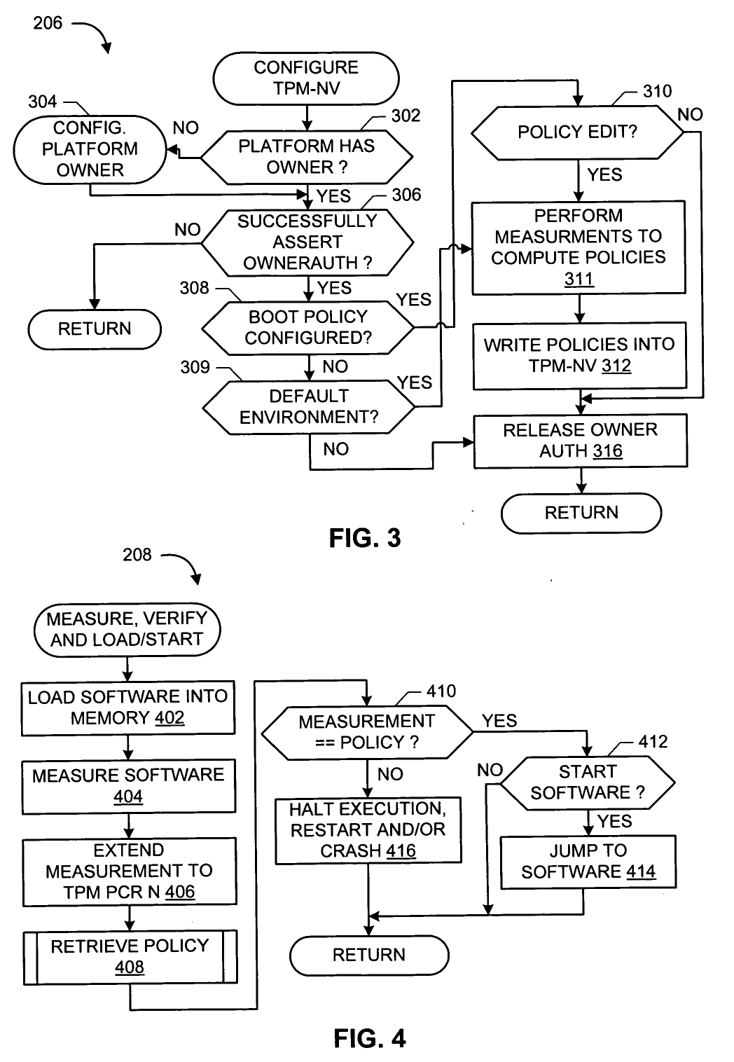

FIG. 2 is a flowchart of an example process 200 to perform a secure boot. The system 100, such as a computer platform, is powered-on from an inactive state and/or is reset to cause a chip-set reset of the ME 102. The ME 102 invokes the TPM interface 106 to initialize the TPM 104, which contains endorsement keys, other private keys, TPM-NV 134, and cryptographic modules (block 202). The platform 100 may be booted in an environment dictated by one or more policies, such as policies stored in TPM-NV 134, or may boot in a default environment (block 204). For example, a generic SOS could invoke a TPM-NV configuration process (block 206) and then restart the boot process, as needed. In general, configuration of the TPM-NV 134 (block 206) determines if the platform 100 includes an authorized owner, whether policies are provided, and/or computes policies if none are available. Additional details regarding the example configuration of the TPM-NV 134 (block 206) are shown in FIG. 3.

Upon completion of TPM-NV configuration (block 206), if necessary, the ME 102 invokes the TPM 104 to perform a measure/verify/start (MVS) operation on the CRTM 132, which results in a calculated hash value (block 208). During each part of the initialization of the system 100, the ME 102 calls a measure/verify/start routine (block 208) that provides the requesting code. For example, the system starts with the CRTM 132 as the trusted genesis software, and that trust is extended/propagated incrementally only if a measurement and corresponding verification match trusted hash values stored in the TPM-NV 134. Alternatively, a series of measurements and starts may occur before a verification. In such a case, binaries that fail the verification process may be immediately halted to minimize harmful effects of erroneous and/or malicious code. As discussed in further detail below, the illustrated example process of FIG. 2 extends/propagates trust from the CRTM 132 to the AMT 138 (block 210). If verification is successful, the system 100 attempts to verify the BIOS 130 (block 212), then the SMM (block 214), then the MBR (block 216). In the illustrated example, the platform 100 executes a plurality of virtual machines (VM), thus includes a measure/verify (MV) operation on the LDR1 156 (block 218), an MV operation on the SINIT ACM 113 (block 220), an MV operation on the LDR2 158 (block 222), and starts the LDR1 156, LDR2 158, and SINIT 113 (block 224). The example process also invokes an MV process on the VMM 154 (block 226, jumps to the VMM 154 if verification is successful (block 228), and then performs an MV operation on the SOS 150 (block 230). The SOS 150 is virtualized, initialized, and launched (block 232) prior to virtualization, initialization, and launch of the UOS 148 (block 234). If verification fails at any point in the incremental initialization, then further initialization is not allowed to proceed. Persons of ordinary skill in the art will appreciate that the process of platform measurement, verification, and initialization of platform elements may be performed in many differing orders, which are typically dependent upon each particular platform hardware, firmware, and/or software design. For example, as described above, some systems 100 include multiple processors and/or a virtual machine monitor (VMM) to enable the end-user to create a plurality of virtual machines (VM) all sharing a common set of platform hardware.

FIG. 3 is a flowchart showing additional detail of the example process 206 of FIG. 2. As described above, the platform 100 may be received by the end-user with a non-initialized TPM-NV 134 and no endorsement key, such as a private endorsement key for encryption, decryption, and/or signing operations. As such, the platform is deemed not to have an owner (block 302) and calls an ownership configuration routine (block 304) to establish an owner with the platform (not shown). After completion of the ownership configuration routine (block 304), or if a default endorsement key was generated during the manufacturing process, the owner may attempt to assert authorization credentials and allow TPM-NV configuration (block 306). Failed attempts at asserting ownership return program control to the calling process or fail.

However, successful assertion of ownership credentials (block 306) allow the system 100 to determine whether the boot policy is configured (block 308). If not, a boot flag may be set to bypass the TPM-NV configuration (block 206) upon subsequent platform 100 boots. For example, if no policies are provided (block 308), then a default environment may be initiated (block 309), in which case the TPM 104 performs measurements on binaries and/or executable code deemed trustworthy (block 311). Such trust is particularly evident when the platform has never been outside the manufacturer's control and/or connected to an intranet and or the Internet. Alternatively, a default environment may immediately direct the process to halt/return (block 309) after releasing owner authority (block 316). The measurement produces a unique hash value(s) with the boot code (block 311), and the hash value(s) is written to the TPM-PCR 136 (block 312) for later recall during verification procedures. If the boot policy has already been configured at least once before (block 308), the user may be requesting a policy edit (block 310), which permits policy computation(s) (block 311). Accordingly, the authorized end-user may still invoke the TPM-NV process (block 206) to edit and/or change policy values, as needed. For example, secure hash values stored in the TPM-NV 134 may require modification when the end-user adds sub-processes to the BIOS, such as when additional or alternative platform hardware is added and/or removed. In such a case, the first executables may be different and the end-user may, consequently, re-measure the CRTM 132 and store the new CRTM hash value in the policies of the TPM-NV 134. Owner authorization is released (block 316) to prevent further changes to the TPM-NV 134, thereby minimizing corruption and/or preventing accidental and/or intentional modification of the hash value(s) stored in the TPM-NV 134. Persons of ordinary skill in the art will appreciate that the TPM-NV 134 may include many separate physical and/or virtual memories, wherein the particular TPM-NV 134 accessed during the TPM-NV configuration process (block 206) is only modified when appropriate owner credentials are asserted. Accordingly, alternate TPM-NV memories may be written to and/or edited to store policy information for alternate verification purposes.

As discussed above, the system 100 begins execution from a trusted genesis, which may be the CRTM code 132. Accordingly, the policy written to the TPM-NV 134 (block 312) may include the hash value associated with the CRTM 132 so that any subsequent boot refers to this secure hash value before allowing the process 200 of FIG. 2 to continue. Additionally, measurements stored in the TPM-PCR 136 may be reported to the policy authoring server 160. Many alternate and/or updated policies may be stored in the storage 162 of the policy authoring server 160 so that the TPM-PCR 136 measurement reference may identify an associated policy. Once the policy authoring server 160 identifies the representative policy in the storage 162, it is provided to the TPM 104 and stored in TPM-NV 134.

FIG. 4 is a flowchart showing additional detail of the example process 208 to perform MVS and/or MV operations. The ME 102 loads requesting software (the CRTM 132 in this example case) into memory (block 402). The TPM 104 measures the loaded software to calculate a hash value (block 404) and extends/propagates the calculated measurement to one of several PCRs 136 (block 406). The TPM 104 may include, for example, a first set of PCRs for the pre-OS state (e.g., PCRs 0-7), and a second set of PCRs for the static-OS state (e.g., PCRs 8-15). Without limitation, a third set of PCRs (e.g., 16-21) may be employed to record measurements of a dynamic root of trust for measurement (e.g., LT technology) that includes, for example, the VMM LDR2 158 and/or SOS images 150. The TPM 104 refers to policy information to determine whether the calculated software verifies as safe by retrieving the policy information from memory and/or storage (block 408). However, the TPM 104 may have a limited amount of memory on which to store policy information, especially in view of advanced and complex computing platforms that require many varying initialization routines.

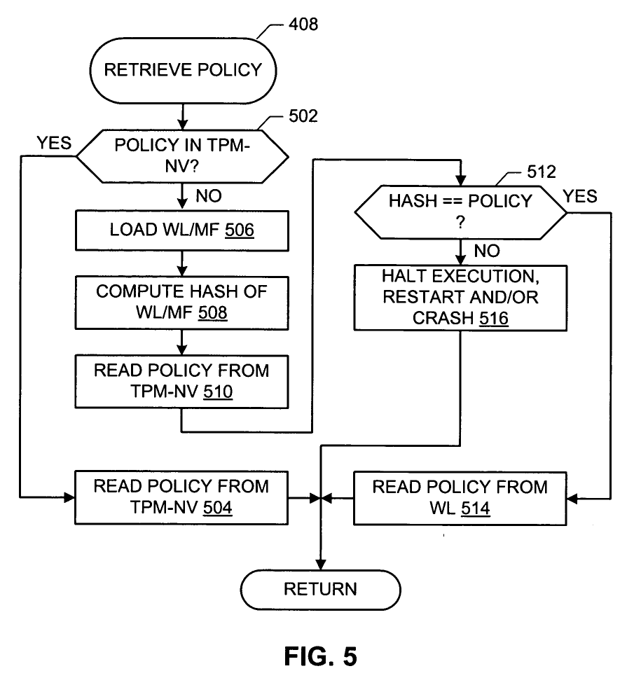

Policy retrieval (block 408) is discussed in further detail below and shown in further detail in FIG. 5. The policy returned is compared to the measurement stored in the PCR 136 for verification (block 410). Additionally, or alternatively, the measurement may be stored in a memory, particularly in view of efficiency concerns when extending measurements blended with previous measurements. As such, verification may occur using the memory instead of, or in addition to the PCRs 136. If equal, then the ME 102 determines whether or not the verified software should be started (block 412). If the software should be started (block 412), the ME 102 jumps to the software executable that was measured at block 404 (block 414). Otherwise, the ME 102 may instruct the verified software to start at a later time. Generally speaking, the MVS process/operation may, or may not, include a start instruction. If the policy does not equal the measurement stored in the PCR 136 (block 410), then execution is halted and an error is reported (block 416). Control returns to block 210 of FIG. 2, which follows additional boot procedures specific to the system 100. As discussed above, the example process of FIG. 2 may include alternate and/or additional processes depending on system 100 hardware, firmware, and/or software.

If the policy information is stored in the TPM-NV 134 (block 502), the policy information is read from the TPM-NV (block 504) and control proceeds to block 410, as discussed in further detail below. However, because numerous policies may consume large amounts of memory space and require an impractical amount of TPM-NV 134 in the TPM 104, a policy object, a manifest, and/or a whitelist (hereinafter “whitelist” ) 152 is loaded into memory (block 506). Accordingly, rather than require that the TPM-NV 134 store a plurality of individual hashes of the whitelist 152, the TPM-NV 134 can store a single consolidated or composite hash value that is representative of all hashes of the whitelist 152. As discussed above, the authorized end-user may store the composite hash value in the TPM-NV 134 in the example manner illustrated in FIG. 3. As a result, if any one of the plurality of software routines of the whitelist change, the stored whitelist hash value stored in the TPM-NV 134 will no longer match (non-parity) a measured hash value, thereby exposing an integrity status of the whitelist. The integrity status may indicate potential platform security breaches and/or other initialization process corruption. The TPM 104 computes a hash of the whitelist 152 (block 508), reads the policy from the TPM-NV 134 that is purportedly associated with the whitelist 152 (block 510), and determines whether the calculated whitelist 152 hash equals the hash stored in the TPM-NV 134 (block 512). If the hashes are equal (block 512), then any software executables stored in the whitelist 152 are presumed safe/valid for execution on the system 100, and any such policy (hash value) associated with the requesting software is read from the whitelist 152 (block 514) and returned to block 410.

On the other hand, if the computed hash (from block 508) does not equal the policy stored in TPM-NV 134 (block 512), then execution is halted (block 516). A condition of non-equality between the computed hash (block 508) and the policy may be indicative of a corrupt whitelist 152 based on, for example, hardware errors or malicious infiltration of the system 100. Additionally, while the hash comparison (block 512) described above considers comparing the hash of a computed whitelist, such hash comparisons (block 512) may include, but are not limited to, comparing a hash of acceptable code, comparing a hash of an acceptable list, and/or comparing a hash of a public key. For example, the hash may identify the public key used to digitally sign lists of hash values describing acceptable code.

While an attacker may be able to replace a current whitelist 152 with an alternate or previous whitelist, thereby causing application of an incorrect policy, a sequence number may be employed to mitigate such replacement. The sequence number is, for example, compared with a reference sequence number stored in the TPM-NV 134 when the first policy was applied. Accordingly, all subsequent whitelist sequence numbers must be larger than the saved sequence number, or the policy is deemed suspicious, thereby preventing potentially malicious code.

As discussed briefly above, the example initialization process 200 calls the MVS or MV process (see FIG. 4) for the AMT software 138 (block 210). Similarly, the MVS process of FIG. 4 is repeated for every facet of system 100 initialization software to verify safety in an incremental manner. The BIOS 130 MVS (block 212) stores a resulting hash value in PCR 0, which may be used as an incremental marker for troubleshooting purposes, discussed in further detail below. MVS operates on the SMM (block 214), but refrains from starting the SMM upon successful verification. As described above, a verified facet of initialization software may be started at a later time, as needed. MVS operates on the MBR 146 (block 216), the VMM LDR1 156 (block 218), the SIMT ACM 113 (block 220), and the VMM LDR2 158 (block 222). PCR 4, 8, 17, and 18 are each loaded with hash values corresponding to the MBR 146, VMM LDR1 156, SINIT ACM 113, and VMM LDR2 158, respectively. Accordingly, if the system 100 encounters any anomaly or suspected breach of security, the ME 102 can refer to the various PCR values as a virtual trail of breadcrumbs to determine which facet of the system 100 initialization failed.

In the illustrated example, the LDR1 156, the LDR2 158, and the SINIT ACM 113 are started at a different times than the measurements and verifications (shown in FIG. 4) (block 224). Persons of ordinary skill in the art will appreciate that measurement and verification may occur at any time prior to the start of a software executable after such executable software is deemed safe. MVS continues to operate on the VMM 154 (block 226) and store the resulting hash in PCR 20, which assist in the troubleshooting process as described above. The ME 102 allows the verified VMM 154 to begin execution with a jump instruction (block 228). In the illustrated example, MVS continues to operate on the SOS 150 and store the hash in PCR 21 (block 230), virtualize, initialize, and launch the verified SOS (block 232), and virtualize, initialize, and launch the UOS 148 (block 234). Accordingly, if the various incremental measurements and verifications of initialization software are successful, the hand-off to the UOS 148 can occur with less concern that the initialization process was breached and/or otherwise corrupted.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method of securely initializing a platform, the method comprising:
receiving an initialization routine, the initialization routine comprising at least one sub-routine;
measuring the initialization routine to compute a hash value;
comparing the computed hash value with a core root of trust hash value to verify the initialization routine;
establishing trust of the initialization routine when the computed hash value matches the core root of trust hash value; and
handing-off platform hardware to an operating system in response to successful verification of the initialization routine.

2. A method as defined in claim 1, wherein receiving the initialization software routine comprises receiving at least one basic input/output system (BIOS) executable.

3. A method as defined in claim 2, wherein the at least one BIOS executable comprises a first core root of trust executable.

4. A method as defined in claim 1, wherein measuring the initialization routine comprises storing the computed hash value in at least one of a platform configuration register (PCR) or a platform memory.

5. A method as defined in claim 1, wherein comparing the computed hash value comprises:
providing the computed hash value to at least one of a trusted platform module or a platform memory;
extracting the core root of trust hash value from secure non-volatile memory, and;
verifying parity between the computed hash value and the core root of trust hash value.

6. A method as defined in claim 1, wherein receiving the initialization routine comprises receiving a first and a second sub-routine, the second sub-routine depending on execution of the first sub-routine for platform initialization and received when the first sub-routine is trusted.

7. A method as defined in claim 1, further comprising obtaining at least one policy, the policy comprising at least one core root of trust hash value.

8. A method as defined in claim 7, further comprising extracting the at least one policy from at least one of a manifest, a whitelist, or a policy object, the manifest, whitelist, or policy object comprising a plurality of hash values corresponding to a plurality of sub-routines.

9. A method as defined in claim 8, further comprising measuring the at least one manifest, whitelist, or policy object to calculate a first composite hash value, the first composite hash value stored in a secure memory.

10. A method as defined in claim 9, further comprising calculating a second composite hash value and comparing the first composite hash value with the second composite hash value to determine an integrity status of the at least one of the whitelist, the manifest, or the policy object.

11. A method as defined in claim 7, further comprising establishing a reference sequence identifier with the at least one policy, the reference sequence identifier stored in a secure memory.

12. A method as defined in claim 11, further comprising comparing the reference sequence identifier with a policy sequence identifier, the at least one policy rejected when the policy sequence identifier is less than the reference sequence identifier.

13. A method as defined in claim 1, further comprising tracking a status of a plurality of sub-routines to identify platform initialization progress.

14. An apparatus to securely initialize a platform, the apparatus comprising:
a manageability engine to invoke requests for trust of at least one initialization routine;
a core root of trust hash value to compare a calculated hash value with the core root of trust hash value to verify the at least one initialization routine; and
a trusted platform module to receive the at least one initialization routine, the trusted platform to measure the at least one initialization routine to calculate the hash value.

15. An apparatus as defined in claim 14, wherein the core root of trust hash value is stored on at least one of a read-only memory (ROM), a random access memory (RAM), or a flash memory.

16. An apparatus as defined in claim 14, wherein the at least one initialization routine comprises a basic input/output system (BIOS) routine, the BIOS routine comprising a core root of trust for measurement (CRTM).

17. An apparatus as defined in claim 14, further comprising a plurality of platform control registers (PCRs) to store measured initialization routine hash values, the PCRs identifying a success status of the at least one initialization routine.

18. An apparatus as defined in claim 14, wherein the manageability engine invokes requests for trust for at least one of a core root of trust for measurement (CRTM), an active management technology (AMT) routine, a basic input/output system (BIOS) routine, a system management mode (SMM) routine, a master boot record (MBR), a virtual machine monitor (VMM), a VMM loader, a service operating system (SOS), or a user operating system (UOS).

19. An article of manufacturing storing machine readable instructions which, when executed, cause a machine to:
receive an initialization routine, the initialization routine comprising at least one sub-routine;
measure the initialization routine to compute a hash value;
compare the computed hash value with a core root of trust hash value to verify the initialization routine;
establish trust to the initialization routine when the computed hash value matches the core root of trust hash value; and
hand-off platform hardware to an operating system in response to successful verification of the initialization routine.

20. An article of manufacture as defined in claim 19 wherein the machine readable instructions cause the machine to receive at least one basic input/output system (BIOS) executable.

21. An article of manufacture as defined in claim 20 wherein the machine readable instructions cause the machine to execute a first core root of trust executable of the BIOS.

22. An article of manufacture as defined in claim 19 wherein the machine readable instructions cause the machine to store the computed hash value of the initialization software routine in at least one of a platform configuration register (PCR) or a platform memory.

23. An article of manufacture as defined in claim 19 wherein the machine readable instructions cause the machine to:
provide the computed hash value to a trusted platform module;
extract the core root of trust hash value from secure non-volatile memory; and
verify parity between the computed hash value and the core root of trust hash value.

24. An article of manufacture as defined in claim 19 wherein the machine readable instructions cause the machine to receive a first and a second sub-routine, the second sub-routine depending on execution of the first sub-routine for platform initialization and received when the first sub-routine is trusted.

25. An article of manufacture as defined in claim 19 wherein the machine readable instructions cause the machine to obtain at least one policy, the policy comprising at least one core root of trust hash value.

26. An article of manufacture as defined in claim 25 wherein the machine readable instructions cause the machine to extract the at least one policy from at least one of a manifest, a whitelist, or a policy object, the manifest, whitelist, or policy object comprising a plurality of hash values corresponding to a plurality of sub-routines.

27. An article of manufacture as defined in claim 26 wherein the machine readable instructions cause the machine to measure the at least one manifest, whitelist, or policy object to calculate a first composite hash value, the first composite hash value stored in a secure memory.

28. An article of manufacture as defined in claim 27 wherein the machine readable instructions cause the machine to:
calculate a second composite hash value; and
compare the first composite hash value with the second composite hash value to determine an integrity status of the at least one of the whitelist, the manifest, or the policy object.
